(19) United States
(12) Patent Application Publication
(10) Pub. No.: US 2009/0101724 A1
(43) Pub. Date: Apr. 23, 2009

(54) APPARATUS FOR RECEIVING AND STORING BANKNOTES

(75) Inventor: Stephen Byerley, Croydon (GB)

Correspondence Address: CANTOR COLBURN, LLP, 20 Church Street, 22nd Floor, Hartford, CT, 06103, US

(73) Assignee: CASH BASES LIMITED, East Sussex (GB)

(21) Appl. No.: 12/257,086

(22) Filed: Oct. 23, 2008

(30) Foreign Application Priority Data
Oct. 23, 2007 (GB) 0720746.7

(51) Int. Cl. G07G 1/00

(52) U.S. Cl. 235/7 R

(57) ABSTRACT

A cash drawer unit is disclosed having a cash drawer moveable between an open position and a closed position, a plunger, and a storage box for storing banknotes and having a slot for receiving the banknotes. The plunger and the storage box are mounted for relative movement therebetween when the cash drawer unit is moved between the open and closed positions. The plunger and the storage box are arranged so as to be spaced apart when the cash drawer unit is in its open position thus allowing a banknote to be placed between the plunger and the slot, the relative movement of the plunger and the storage box causing the plunger to push the banknote through the slot into the storage box.

### CROSS REFERENCE

This application claims the benefit of a priority under 35 U.S.C. 119 to United Kingdom Patent Application No. 0720746.7 filed 23 Oct. 2007, the entire contents of which are hereby incorporated by reference.

### BACKGROUND OF THE INVENTION

The present invention relates to apparatus for receiving and storing banknotes.

Existing devices for storing quantities of banknotes at a point of sale are provided externally of the cash drawer or cash register. Typically the devices are secured to the side or underside of a cashdesk. One disadvantage with such an arrangement is that the storage device is permanently visible to anyone wishing to gain unauthorised access to the stored banknotes.

The present invention attempts to overcome or mitigate this disadvantage by providing a note storage device within a cash drawer unit.

### BRIEF DESCRIPTION OF THE INVENTION

According to an embodiment of the present invention, there is provided a cash drawer unit comprising:

a cash drawer moveable between an open position and a closed position;

a plunger; and

a storage box for storing banknotes and comprising a slot for receiving the banknotes;

wherein the plunger and the storage box are mounted for relative movement therebetween when the cash drawer unit is moved between the open and closed configurations; and wherein the plunger and the storage box are arranged so as to be spaced apart when the cash drawer unit is in its open position thus allowing a banknote to be placed between the plunger and the slot, the relative movement of the plunger and the storage box causing the plunger to push the banknote through the slot into the storage box.

Preferably, the cash drawer unit comprises a housing and the cash drawer is mounted for reciprocating movement with respect to the housing.

In a first embodiment of the invention, the plunger is fixedly mounted with respect to the housing and the storage box is mounted on the cash drawer so as to be moveable with the cash drawer.

A note receiving space is preferably provided between the storage box and the plunger and may be defined at least in part by at least one wall provided on the cash drawer and having a slot aligned with the slot provided on the storage box and with the plunger. A rear wall of the storage box itself preferably forms another wall of the note receiving space.

Preferably, the cash drawer unit further comprises means for locking the storage box to the cash drawer so as to prevent unauthorised removal of the storage box. The locking means may comprise a locking bar slidably mounted to the cash drawer, the locking bar including a latching portion adapted to engage a slot provided on the storage box when the storage box is mounted on the cash drawer.

In a second embodiment of the invention, the storage box is mounted to the housing in a fixed position and the plunger is mounted on the cash drawer so as to be moveable with the cash drawer.

A note receiver is preferably provided between the storage box and the plunger and may be slidably mounted on the cash drawer.

The note receiver may comprise two spaced apart walls, preferably both including a slot aligned with the slot provided on the storage box and with the plunger.

In a third embodiment of the invention, the plunger and the storage box are both mounted on the cash drawer.

Preferably, the storage box is slidably mounted on the cash drawer aft of the plunger.

A note receiving space may be provided between the storage box and the plunger and is preferably defined by at least one wall provided on the cash drawer and including a slot aligned with the slot provided on the storage box and with the plunger.

Most preferably a note receiver is defined between two spaced apart walls.

The wall or walls may be slidably mounted on the cash drawer so as to slide in unison with the storage box.

The cash drawer unit may further comprise a stop, for example a projection, fixed to the housing for engaging the storage box during closing of the cash drawer so as to move the storage box relative to the plunger.

A retainer may be provided for retaining the storage box in its closed position during initial opening of the cash drawer, thus allowing the plunger to retract from the storage box. A catch may be provided on the cash drawer for engaging the storage box after a predetermined movement of the cash drawer to disengage the storage box from the retainer.

In one embodiment, the retainer may be magnetic. Preferably the aforementioned stop is magnetic.

Alternatively or additionally the cash drawer unit may comprise biasing means provided between the note receiver and the plunger so as to bias the note receiver and the note storage box away from the plunger such that the plunger disengages from the storage box as the cash drawer opens. The biasing means may comprise at least one spring.

In further embodiments, the cash drawer unit may also be provided with a locking pin for restricting the movement of the cash drawer. The locking pin is preferably arranged so as to prevent the cash drawer being fully opened, but may also be disengageable so as to permit the drawer to be fully opened when necessary.

In any of the embodiments described above, the plunger can comprise a plate sized to fit within the slot provided on the storage box.

In the various embodiments above, the slots provided in walls of the note receiver may be deeper than the slots in the storage box in order to facilitate initial bending of the banknote as the plunger passes through the wall.

The storage box may further comprise a hinged lid, which in some embodiments includes a lock for locking the lid in a closed position. Preferably, the storage box also comprises a plate resiliently mounted within the storage box such that the plate is in a facing relationship with the slot. Biasing means may be mounted between the plate and a wall of the storage box so as to bias the plate towards the slot. For example, the biasing means may comprise at least one spring.

Preferably, the storage box is removable from the cash drawer unit so as to permit the storage box to be taken to a location remote from the cash drawer unit for removal of the stored banknotes.

### BRIEF DESCRIPTION OF THE DRAWINGS

Embodiments of the present invention will now be described by way of example only and with reference to the accompanying drawings, in which:

FIG. 1 shows a first embodiment of a cash drawer unit in accordance with an embodiment of the present invention;

FIG. 2 shows a perspective view of the cash drawer unit of FIG. 1 with its housing removed;

FIG. 3 shows a perspective view of a storage box for use in the cash drawer unit of FIG. 1:

FIG. 4 shows a perspective view of the storage box of FIG. 3 with its lid removed;

FIG. 5 shows the front wall and the locking bar of the cash drawer unit of FIG. 2;

FIG. 5a shows an enlarged view of the latching portion of the locking bar of FIG. 5;

FIG. 6 shows a second perspective view of the cash drawer unit of FIG. 2;

FIG. 7 shows a second embodiment of a cash drawer unit in accordance with an embodiment of the present invention;

FIG. 8 shows the cash drawer unit of FIG. 7 in a closed state;

FIG. 9 shows a third embodiment of a cash drawer unit in accordance with an embodiment of the present invention; and

FIG. 10 shows the cash drawer unit of FIG. 9 in a closed state.

### DETAILED DESCRIPTION OF THE INVENTION

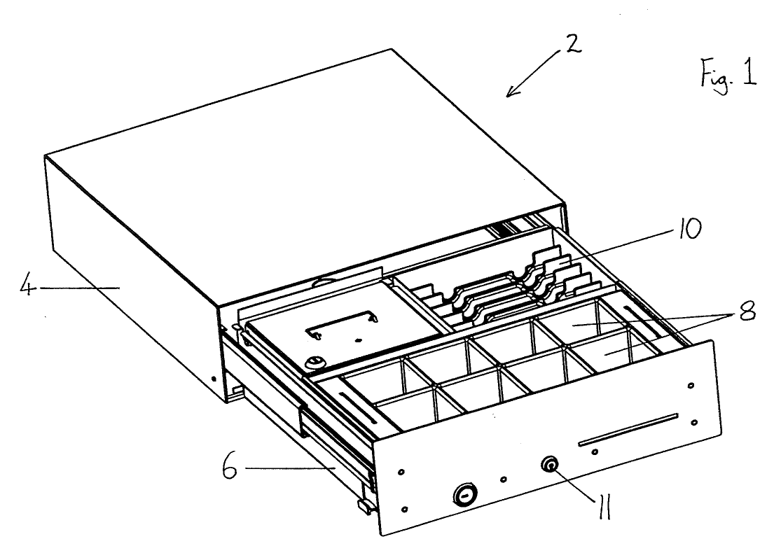

FIG. 1 shows a cash drawer unit 2 in accordance with a first embodiment of the present invention. The cash drawer unit 2 comprises a housing 4 and a cash drawer 6 mounted for reciprocating movement into and out of the housing 4. The cash drawer 6 may comprise coin cups 8 and/or note dividers 10, as is known in the art. The coin cups 8 and the note dividers 10 may be fixed within the cash drawer 6 or may be removable. The cash drawer 6 may also comprise a lock 11 to lock the drawer 6 in a closed position.

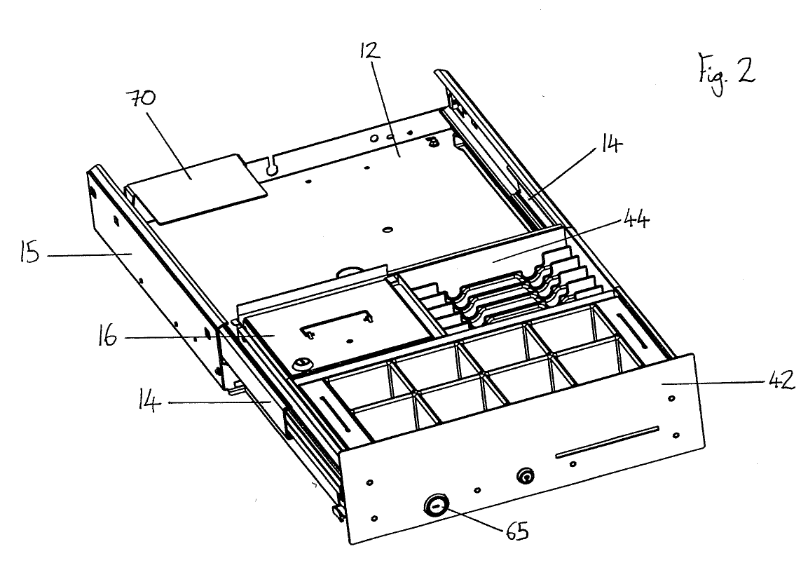

As can be seen from FIG. 2, in which the housing cover has been removed, the housing 4 further comprises a base 12 which may be fixed to a cash desk or other surface (not shown) using suitable means. The cash drawer 6 is slidably mounted in runners 14 provided on side walls 15 of the housing.

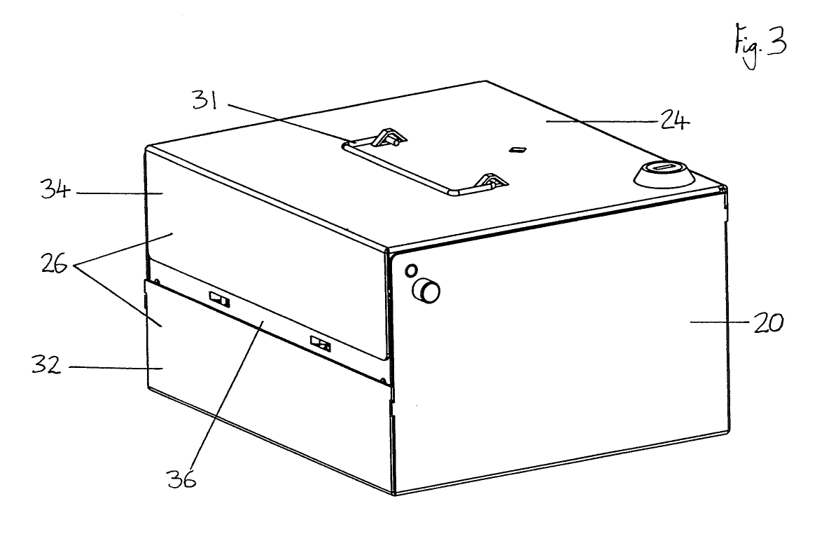

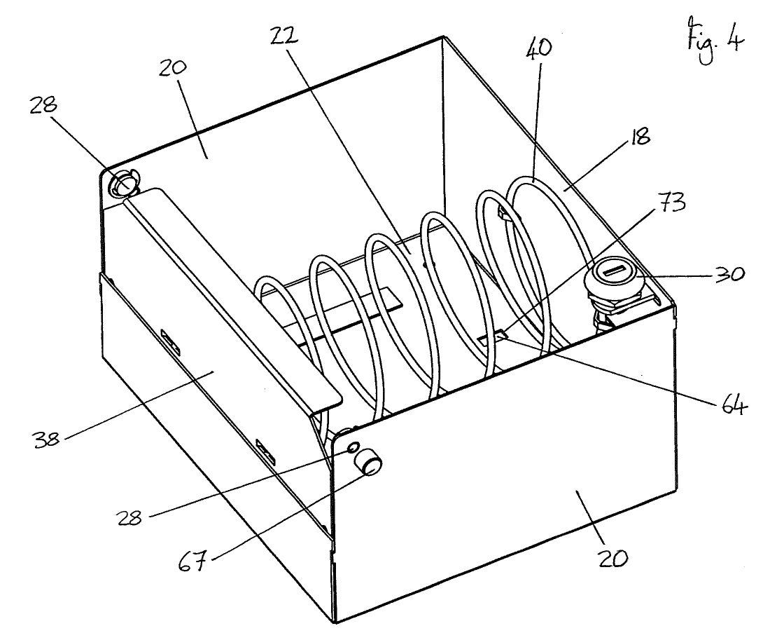

As shown in FIGS. 1 and 2, the cash drawer unit 2 also comprises a removable storage box 16 located within the cash drawer 6 for receiving and storing banknotes. The storage box 16 will now be described in detail with reference to FIGS. 3 and 4.

As shown in FIGS. 3 and 4, the storage box 16 comprises a front wall 18, two side walls 20, a base 22, a lid 24 and a back wall 26. The lid 24 is pivotably mounted to the side walls 20 about pivots 28 and the storage box 16 is provided with a lock 30 to lock the lid 24 in the closed position. A handle 31 may also be provided on the lid 24.

The back wall 26 is formed of a lower wall portion 32, which is fixedly attached to the two side walls 20 and the base 22, and an upper wall portion 34 which is attached to and moveable with the lid 24. In an alternative embodiment, the upper wall portion 34 may be formed separately from the lid 24 and fixedly attached to the side walls 20 in the same manner as the lower wall portion 32. The lower and upper wall portions 32,34 are space apart so as to form a slot 36 for receiving banknotes.

Referring still to FIG. 4, the storage box 16 further comprises a moveable plate 38 located inside the box 16 in a facing relationship with the slot 36. The moveable plate 38 is biased towards the slot 36 by a spring 40 provided between the plate 38 and the front wall 18.

Referring now to FIGS. 2, 5 and 6, the cash drawer 6 includes a front wall 42 and a back wall 44. A slot 45 is provided in the back wall 44 and is aligned with the slot 36 provided in the storage box 16 when the storage box 16 is located in the cash drawer 6. The back wall 44 is spaced from the back wall 26 of the storage box 16 so as to define a note receiving space therebetween.

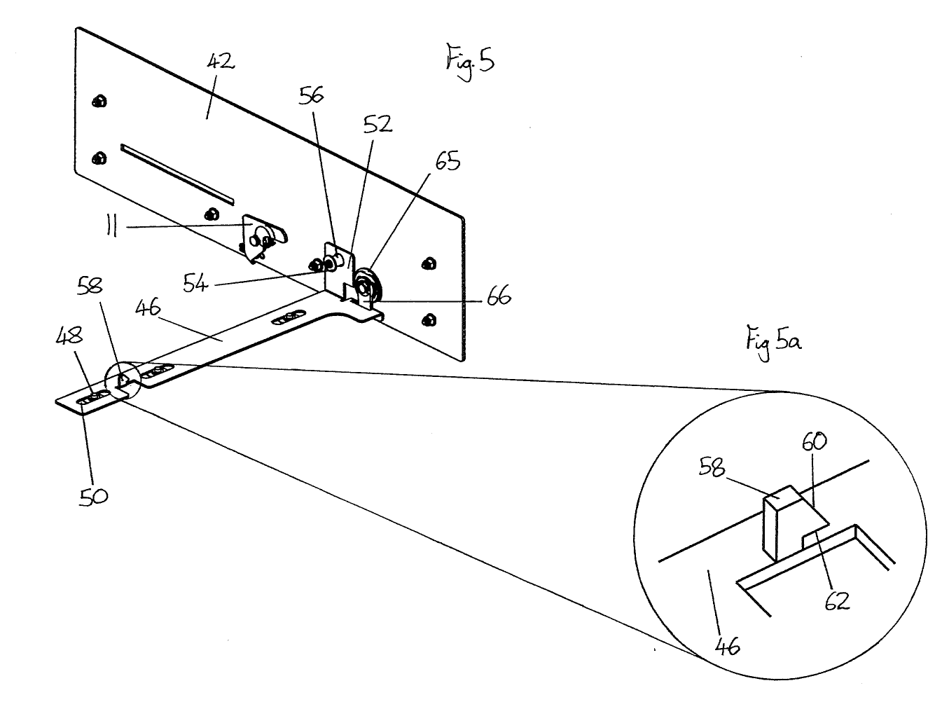

FIG. 5 shows the front wall 42 as viewed from inside the cash drawer unit 2. As can be seen from FIG. 5, a locking bar 46 is provided for locking the storage box 16 in place within the cash drawer 6 to prevent unauthorised removal of the storage box. The locking bar is slidably mounted to the base of the cash drawer 6 using rivets 48 attached to the floor of the cash drawer unit and projecting up into slots 50 provided in the locking bar 46. The locking bar 46 is biased towards the front wall 42 of the cash drawer 6 by spring means (not shown) mounted between an upstanding portion 52 of the locking bar 46 and a flange 54. The flange 54 is provided on a post 56 which is attached to the front wall 42 and extends through a hole in the upstanding portion 52 of the locking bar 46.

The locking bar 46 further includes a latching portion 58 which comprises a camming surface 60 and a latching surface 62. The latching portion 58 engages a hole 64 (FIG. 4) provided in the base 22 of the storage box 16 to secure the storage box 16 to the cash drawer 6. A push-button lock 65 comprising an actuating arm 66 is provided for releasing the storage box 16.

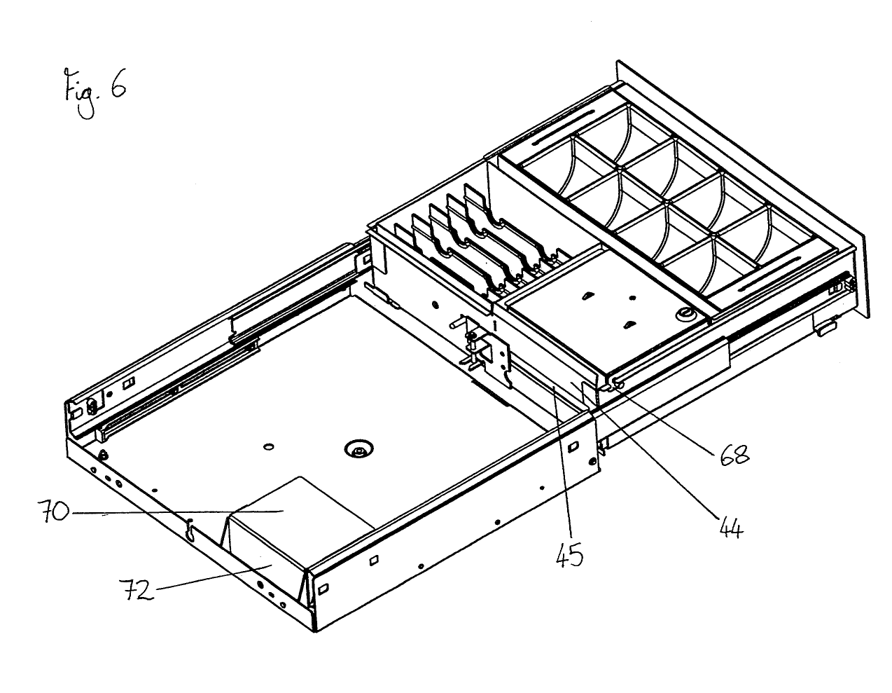

As can be seen from FIGS. 4 and 6, the storage box may also include a lug 67 for engaging an L-shaped slot 68 provided in the edge of the cash drawer 6 to further secure the cash drawer 6 in place.

As shown in FIGS. 2 and 6, the cash drawer unit 2 also includes a plunger 70 comprising a horizontal plate fixedly attached to the base 12 of the cash drawer unit 2 by an upstanding support 72. The plunger 70 is sized to fit within the slot 36 of the storage box 16 and arranged within the cash drawer unit 2 so as to enter the slot 36 when the cash drawer 6 is closed.

The operation of the cash drawer 6 and the storage box 16 will now be described in detail.

To prepare the cash drawer unit 2 for securely storing banknotes, an empty storage box 16 is installed in the cash drawer 6. As the storage box 16 is lowered into the cash drawer 6, the front end 73 of the hole 64 in the base of the storage box 16 will engage the camming surface 60 of the latching portion 58 provided on the locking bar 46. As the storage box 16 is lowered further, the front end 73 of the hole 64 will act on the camming surface 60, thus causing the locking bar 46 to slide towards the back of the cash drawer 6. Once the front end 73 of the hole has passed the end of the camming surface 60, the spring means (not shown) acting on the upstanding portion 52 of the locking bar 46 will return the locking bar 46 to its forward position, thus bringing the latching surface 62 of the latching portion into engagement with the base 22 of the storage box 16. At the same time the lug 67 enters and moves along the slot 68 provided on the cash drawer 6.

In order to store banknotes within the storage box 16, the notes are inserted into the note receiving space defined between the back wall 44 of the cash drawer 6 and the back wall 26 of the storage box 16 when the cash drawer 6 is in the open position shown in FIG. 6. Upon closing the cash drawer 6, the plunger 70 will pass through the slots 45,36 provided in the back wall 44 of the cash drawer 6 and the back of the storage box respectively. As the plunger 70 passes through the slots 45,36, any notes within the note receiving space will be pushed through the slot 36 into the storage box 16.

As the plunger 36 pushes the notes into the storage box 16, the moveable plate within the storage box 16 will be forced away from the box a sufficient distance to allow the notes to fully enter the storage box 16. The spring 40 biases the plate 38 towards the plunger 70, trapping the notes therebetween when the cash drawer 6 is in the closed position. Upon opening the cash drawer 6 again, the stored notes will remain trapped between the plate 38 and the back wall 26 of the storage box 16 once the plunger has fully retracted from the slot 36. The plate 38 and the spring 40 therefore serve to ensure that the notes are stored neatly within the storage box 16.

Further notes may be stored within the storage box 16 by repeating the above steps until the storage box 16 is full. In order to remove the storage box from the open cash drawer 6, an authorised user may operate the push-button lock 65 with the appropriate key. Upon opening and pushing on the lock 65, the actuating arm 66 exerts a force on the locking bar 46 so as to slide the locking bar 46 towards the back of the cash drawer 6, thus disengaging the latching surface 62 of the latching portion 58 from the base 22 of the storage box 16. The user may then slide the storage box towards the back of the cash drawer 6 so as to disengage the lug 67 from the slot 68, thus permitting the storage box 16 to be removed. The storage box may be opened at a location remote from the cash drawer unit 2 in order to remove the stored banknotes.

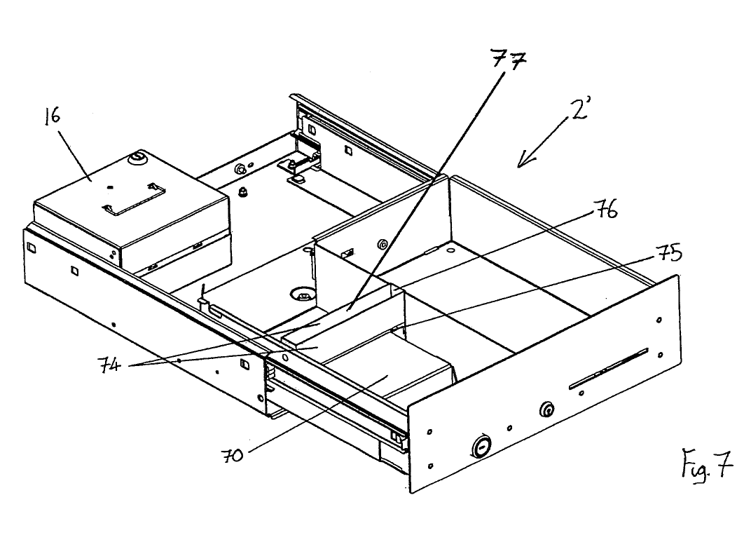

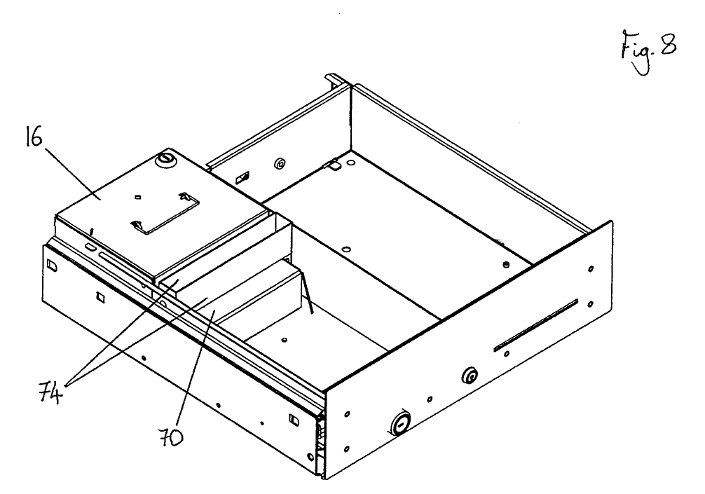

Referring now to FIGS. 7 and 8 there is shown a second embodiment of a cash drawer unit 2′ in accordance with the present invention. In this second embodiment, the locations of the storage box 16 and the plunger 70 have been transposed, i.e. the storage box 16 is mounted to the base 12 of the cash drawer unit 2′ and the plunger is fixedly attached to the cash drawer 6. In order to define the note receiving space, two spaced apart walls 74 are provided in the cash drawer 6 to define a note receiver 77 therebetween. The walls 74 are connected together at their ends by side wall portions 76. Each wall 74 is provided with a slot 75 which is aligned with the plunger 70 and the slot 36 provided on the storage box 16. The walls 74 are slidably mounted on the cash drawer 6 using suitable mounting means, e.g. a runner.

In order to operate the cash drawer unit 2′ disclosed in FIGS. 7 and 8, the banknotes to be stored are placed between the walls 74 when the drawer 6 is in the open position. Upon closing the drawer 6, the rear wall 74 will come into contact with the storage box 16. As the user continues to close the drawer 6, the slidably mounted walls 74 are forced to slide towards the plunger 70 such that the plunger will extend through the slots 75 provided in the wall 74 and into the slot 36 on the storage box 16, thus pushing the notes from the note receiver 77 into the storage box. The walls 74 are preferably biased towards the back of the cash drawer 2′, e.g. by suitable spring means, so that upon opening the cash drawer 6 the walls 74 slide away from the plunger 70 such that the plunger 70 no longer extends through the note receiver 77.

An advantage of this system is that the storage box 16 is not visible when the cash drawer 6 is open. A potential disadvantage is, however, that it may be difficult to access the storage box 16 for emptying.

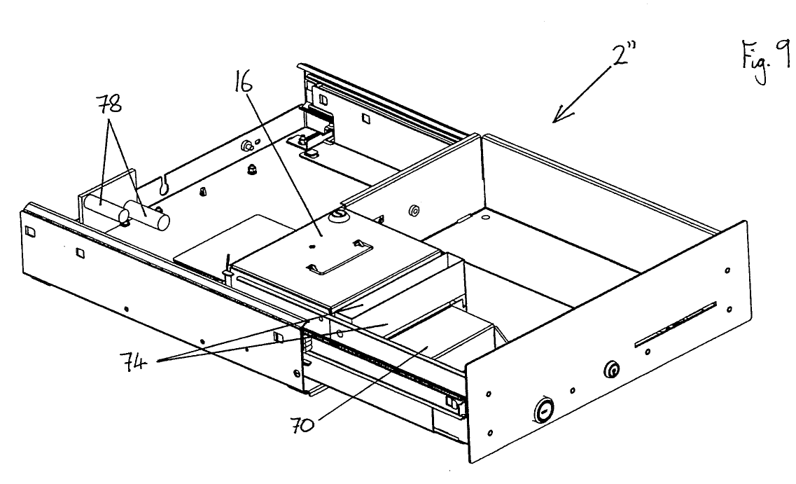

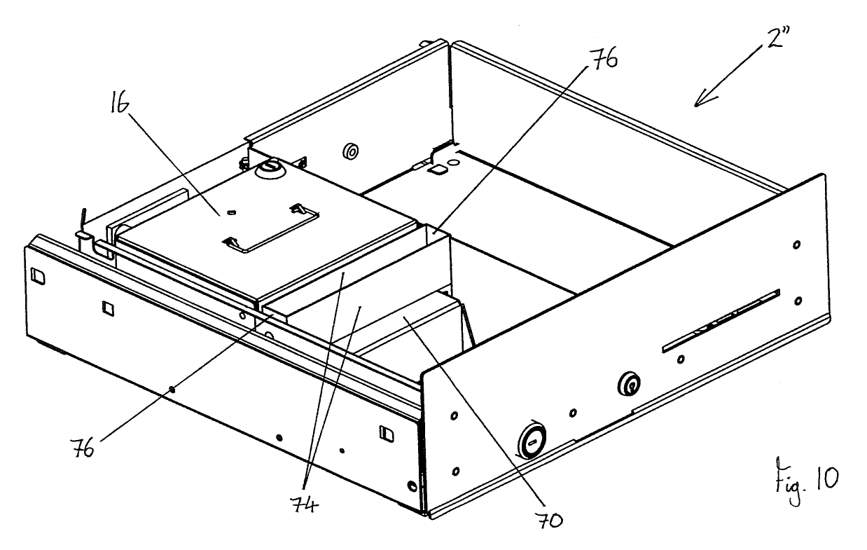

Shown in FIGS. 9 and 10 is a cash drawer unit 2″ according to a third embodiment of the present invention. In the cash drawer unit 2″, the storage box 16 and the plunger 70 are both mounted to the cash drawer 6. A note receiver 77 between the storage box 16 and the plunger 70 is again defined by walls 74 and side walls 76 in a similar manner as cash drawer unit 2′ described with reference to FIGS. 7 and 8. However, it is possible to provide only a single wall 74 so as to define a note receiving space between the forward most wall 74 and the front wall 18 of the storage box 16 itself.

The arrangement of the storage box 16 and the note receiver 77 is such that when the cash drawer 6 is open, only the note receiver 77 and not the storage box 16 is visible to a user.

The cash drawer unit 2″ additionally comprises a magnetic stop 78. In the embodiment shown in FIGS. 9 and 10, the magnetic stop 78 comprises two posts arranged to project from the back wall of the cash drawer unit 21″. The posts may be magnetic or have permanent magnets arranged on their free ends. The function of the magnetic stop 78 will be described in further detail below.

The storage box 16 and the note receiver 77 are slidable within the cash drawer 6 with respect to the plunger 70. The storage box 16 and the note receiver 77 may be slidably mounted to the cash drawer 6 using any suitable means, e.g. a runner or a slidable carriage. However, the storage box 16 is preferably not secured to the cash drawer 6, i.e. the storage box 16 is preferably free to slide within the cash drawer 6, so as to permit easy removal of the storage box 16.

Suitable stopping means, e.g. a lip or a projection, are provided on the back of the cash drawer 6 to prevent the storage box 16 from sliding beyond the back wall of the cash drawer 6.

Suitable linkage means (not shown) are also provided to link the storage box 16 and the note receiver 77 when the storage box 16 is inserted into the cash drawer 6. The linkage means ensure that the storage box 16 and the wall portions 74 slide in unison within the cash drawer 16, as will be described in more detail below. The linkage means could, for example, comprise a carriage in which both are mounted.

To prevent unauthorised removal of the storage box 16, a locking pin is preferably provided within the cash drawer unit 2″. The locking pin prevents the cash drawer 6 from being opened beyond the position shown in FIG. 9, such that removal of the storage box 16 is prevented by the housing. In order to remove the storage box 16, an authorised user may disengage the locking pin to permit the cash drawer 6 to be opened beyond the position shown in FIG. 9, thus permitting removal of the storage box 16. Such a configuration is also advantageous since the storage box 16 remains hidden during normal use of the cash drawer unit 2″.

In order to operate the note storage unit 211, the cash drawer 6 is opened to the position shown in FIG. 9 such that the user may place the banknotes to be stored between the walls 74 of the note receiver 77. Upon closing the cash drawer 6, the storage box 16 will come into contact with the magnetic stop 78. As the user continues to close the drawer 6, the magnetic stop will force the storage box 16 and the note receiver 77 to slide towards the plunger 70. As such, the plunger 70 will extend through the slots 75 provided in the walls 74 and the storage box 16, thus forcing the notes into the storage box 16. Upon opening the drawer 16 again, the magnetic stop 78 will act to retain the storage box 16 and the note receiver 77 in the position shown in FIG. 10 whilst the cash drawer 6 and the plunger 70 slide towards the open position. As the user continues to open the drawer 6, the catch provided on the back of the cash drawer 6 will come into contact with the back of the storage box 16 and therefore pull the storage box away from the magnetic stop 78. The storage box 16 and the note receiver 77 will then continue to move in unison with the cash drawer 6 to the open position shown in FIG. 9. The magnetic stop 78 therefore ensures that upon opening the cash drawer 6, the storage box 16 and the wall portions 74 are returned to the configuration shown in FIG. 9 so as to accept further banknotes for storage.

In an alternative embodiment to that shown in FIGS. 9 and 10, the magnetic stop 78 may be replaced by a non-magnetic stop. In this case, suitable resilient means, e.g. a spring, may be provided between the plunger 70 and the note receiver 77 so as to bias the note receiver 77 and storage box 18 away from the plunger 70. Such spring means would therefore ensure that the storage box 16 and the note receiver 77 are returned to the position shown in FIG. 9 when the cash drawer 6 is opened. The advantage of this alternative arrangement is that it is not necessary to provide linking means to link the storage box 16 and the note receiver 77.

In an alternative embodiment, a stop may be provided on or operatively coupled to the storage box 18 rather than on the housing 12.

It will be appreciated that changes and modifications may be made to the disclosed embodiments without departing from the scope of the present invention. For example, the note storage box 16 need not be removable, but instead may be secured within the cash drawer unit. Furthermore, although the plunger 70 has been described herein as a plate, the skilled person will realise that other shapes will be suitable. For example, the plunger may be in the form of one or more fingers or a comb-like arrangement, or a horizontal bar. Any shape which is sized to fit within the slot provided on the storage box 16 and suitable for pushing the notes into the storage box 16 may be used.

Also, the walls defining the note receiver may be made in one or more pieces. They need not be continuous, so long as they define suitable structure for supporting the banknotes.

Finally, a cash drawer unit according to the present invention is also suitable for storing sheet-like articles other than banknotes, and can be used with any sheet-like articles such as, for example, cheques, vouchers, receipts, credit card slips and ballot papers. The size of the storage box 16 and the plunger 70 will be determined by the size of the sheet-like articles to be stored therein.

1. A cash drawer unit comprising:
a cash drawer moveable between an open position and a closed position;
a plunger; and
a storage box for storing banknotes and comprising a slot for receiving the banknotes;
wherein the plunger and the storage box are mounted for relative movement therebetween when the cash drawer unit is moved between the open and closed positions; and wherein the plunger and the storage box are arranged so as to be spaced apart when the cash drawer unit is in its open position thus allowing a banknote to be placed between the plunger and the slot, the relative movement of the plunger and the storage box causing the plunger to push the banknote through the slot into the storage box.

2. The cash drawer unit of claim 1 wherein the cash drawer unit further comprises a housing, the cash drawer being mounted for reciprocating movement with respect to the housing.

3. The cash drawer unit of claim 2 wherein the plunger is fixedly mounted with respect to the housing and the storage box is mounted on the cash drawer so as to be moveable with the cash drawer.

4. The cash drawer unit of claim 3 further comprising a note receiving space between the storage box and the plunger.

5. The cash drawer unit of claim 4 wherein the note receiving space is defined by at least one wall provided on the cash drawer, the wall having a slot aligned with the slot provided on the storage box and with the plunger.

6. The cash drawer unit of claim 5 wherein a rear wall of the storage box further defines the note receiving space.

7. The cash drawer unit of claim 1 further comprising means for locking the storage box to the cash drawer so as to prevent unauthorised removal of the storage box.

8. The cash drawer unit of claim 7 wherein the locking means comprises a locking bar slidably mounted to the cash drawer, the locking bar including a latching portion adapted to engage a slot provided on the storage box when the storage box is mounted on the cash drawer.

9. The cash drawer unit of claim 2 wherein the storage box is mounted to the housing in a fixed position and the plunger is mounted on the cash drawer so as to be moveable with the cash drawer.

10. The cash drawer unit of claim 9 further comprising a note receiver provided between the storage box and the plunger.

11. The cash drawer unit of claim 10 wherein the note receiver is slidably mounted on the cash drawer.

12. The cash drawer unit of claim 10 wherein the note receiver comprises two spaced apart walls, the walls each including a slot aligned with the slot provided on the storage box and with the plunger.

13. The cash drawer unit of claim 2 wherein the plunger and the storage box are both mounted on the cash drawer.

14. The cash drawer unit of claim 13 wherein the storage box is slidably mounted on the cash drawer aft of the plunger.

15. The cash drawer unit of claim 14 further comprising a stop fixed to the housing for engaging the storage box during closing of the cash drawer so as to move the storage box relative to the plunger.

16. The cash drawer unit of claim 15 wherein the stop comprises a projection.

17. The cash drawer unit of claim 15 further comprising a retainer for retaining the storage box in its closed position during initial opening of the cash drawer so as to permit the plunger to retract from the storage box.

18. The cash drawer unit of claim 17 further comprising a catch provided on the cash drawer for engaging the storage box after a predetermined movement of the cash drawer so as to disengage the storage box from the retainer.

19. The cash drawer unit of claim 17 wherein the retainer is magnetic.

20. The cash drawer unit of claim 15 wherein the stop is magnetic.

21. The cash drawer unit of claim 13 further comprising a note receiving space between the storage box and the plunger.

22. The cash drawer unit of claim 21 wherein the note receiving space is defined by at least one wall provided on the cash drawer, the wall including a slot aligned with the slot provided on the storage box and with the plunger.

23. The cash drawer unit of claim 21 wherein the note receiver is defined between two spaced apart walls.

24. The cash drawer unit of claim 22 wherein the wall is slidably mounted on the cash drawer so as to slide in unison with the storage box.

25. The cash drawer unit of claim 21 further comprising biasing means provided between the note receiver and the plunger so as to bias the note receiver and the note storage box away from the plunger such that the plunger disengages from the storage box as the cash drawer opens.

26. The cash drawer unit of claim 25 wherein the biasing means comprises at least one spring.

27. The cash drawer unit of claim 1 further comprising a locking pin for restricting the movement of the cash drawer.

28. The cash drawer unit of claim 27 wherein the locking pin is arranged so as to prevent the cash drawer being fully opened.

29. The cash drawer unit of claim 28 wherein the locking pin can be disengaged so as to permit the cash drawer to be fully opened.

30. The cash drawer unit of claim 1 wherein the plunger comprises a plate sized to fit within the slot provided on the storage box.

31. The cash drawer unit of claim 1 wherein the storage box further comprises a hinged lid.

32. The cash drawer unit of claim 31 wherein the storage box further comprises a lock for locking the lid in a closed position.

33. The cash drawer unit of claim 1 wherein the storage box further comprises a plate resiliently mounted within the storage box such that the plate is in a facing relationship with the slot.

34. The cash drawer unit of claim 33 wherein the storage box further comprises biasing means mounted between the plate and a wall of the storage box so as to bias the plate towards the slot.

35. The cash drawer unit of claim 34 wherein the biasing means comprises at least one spring.

36. The cash drawer unit of claim 1 wherein the storage box is removable from the cash drawer unit.
